(19) United States
(12) Patent Application Publication
(10) Pub. No.: US 2006/0139726 A1
(43) Pub. Date: Jun. 29, 2006

(54) Electrochromic medium having a self-healing, cross-linked polymer matrix and associated electrochromic device

(75) Inventors: Leroy J. Kloeppner, Jenison, MI (US); Thomas F. Guarr, Holland, MI (US); Kevin L. Ash, Grand Rapids, MI (US); Kathy E. Roberts, East Grand Rapids, MI (US); David A. Theiste, Byron Center, MI (US)

Correspondence Address: KING & PARTNERS, PLC;F/B/O/ GENTEX CORPORATION, 170 COLLEGE AVENUE, SUITE 230, HOLLAND, MI, 49423, US

(73) Assignee: Gentex Corporation

(21) Appl. No.: 11/356,356

(22) Filed: Feb. 16, 2006

Related U.S. Application Data
(63) Continuation-in-part of application No. 10/662,665, filed on Sep. 15, 2003, now Pat. No. 7,001,540.
Application No. 10/662,665 is a continuation of application No. 09/940,944, filed on Aug. 28, 2001, now Pat. No. 6,635,194.

(51) Int. Cl. G02F 1/15

(52) U.S. Cl. 359/265

(57) ABSTRACT

An electrochromic medium for use in an electrochromic device comprising: at least one solvent; an anodic electroactive material; a cathodic electroactive material; wherein at least one of the anodic and cathodic electroactive materials is electrochromic; and a self-healing, cross-linked polymer matrix.

### CROSS-REFERENCE TO RELATED APPLICATIONS

This application is a continuation-in-part of co-pending U.S. application Ser. No. 10/662,665, filed Sep. 15, 2003, which is a continuation of U.S. application Ser. No. 09/940,944, filed Aug. 28, 2001, now U.S. Pat. No. 6,635,194, all of which are hereby incorporated herein by reference in their entirety.

### BACKGROUND OF THE INVENTION

1. Field of the Invention

The present invention relates in general to electrochromic devices, and more particularly, to a gelled electrochromic medium, for use in an electrochromic device, which comprises a self-healing, cross-linked polymer matrix.

2. Background Art

Electrochromic devices have been known in the art for several years. While the utilization of electrochromic devices, such as electrochromic mirrors, has become increasingly popular, for example, among the automotive industry, the undesirable formation of visible irregularities and/or defects within the gelled medium remains problematic.

Indeed, when many conventional electrochromic devices, which utilize a gelled electrochromic medium having a cross-linked polymer matrix, are exposed to a dynamic range of real world temperatures, the gelled medium can become optically unacceptable for commercial use due to the formation of visual irregularities and/or defects.

Factors that are believed to facilitate the formation of the above-identified visible irregularities and/or defects include, among other things: (1) an insufficiently flexible polymer backbone; (2) an insufficient level of cohesive forces within the polymer matrix; and/or (3) an insufficient level of adhesive forces between the polymer matrix and the surface of an associated substrate and/or electrically conductive material.

It is therefore an object of the present invention to provide a gelled electrochromic medium which comprises a self-healing, cross-linked polymer matrix which remedies the aforementioned detriments and/or complications associated with the use of conventional cross-linked polymer matrices within an electrochromic device.

These and other objects of the present invention will become apparent in light of the present specification, claims, and drawings.

### SUMMARY OF THE INVENTION

The present invention is directed to an electrochromic medium for use in an electrochromic device comprising: at least one solvent; an anodic electroactive material; a cathodic electroactive material; wherein at least one of the anodic and cathodic electroactive materials is electrochromic; and a self-healing, cross-linked polymer matrix.

In a preferred embodiment of the present invention, the self-healing, cross-linked polymer matrix comprises: a product of a first reactant having an adhesive/cohesive functional group and a second reactant having a cross-linking functional group; wherein the following inequality is true: f+2(log(r)/p)≧1.00; wherein f comprises Σ_{x/m}; wherein x comprises a value ranging from 0 to 2 for each element (A), aryl moiety (Ar), and cyclic moiety (Cy) of at least one of the first and second reactants; wherein x comprises 0 if A or Ar is represented by one of the following structures: 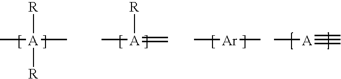
wherein x comprises 0.5 if A or Cy is represented by one of the following structures: 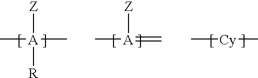
wherein x comprises 1.0 if A is represented by one of the following structures: 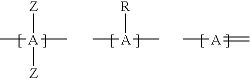
wherein x comprises 1.5 if A is represented by the following structure: 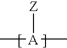
wherein x comprises 2.0 if A is represented by the following structure: 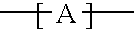
wherein A comprises C, N, O, S, P, or Si; wherein Z comprises H or F; wherein R comprises any other pendent group other than Z; wherein m comprises the number of (A) elements, (Ar) moieties, and (Cy) moieties of the at least one of the first and second reactants which define x; wherein r comprises the molar ratio of the adhesive/cohesive functional group of the first reactant to the cross-linking functional group of the second reactant; and wherein p comprises the total concentration by weight of the self-healing, cross-linked polymer matrix in the electrochromic medium.

In this embodiment, the following inequalities are also preferably true: f+2(log(r)/p)≧1.10; and f+2(log(r)/p)≧1.25.

In this embodiment, the electrochromic medium may further comprise one or more ultraviolet stabilizers.

In another preferred embodiment of the present invention, the average molecular weight of at least one of the first and second reactants is preferably greater than approximately 2,000 daltons, more preferably greater than approximately 5,000 daltons, and most preferably greater than approximately 10,000 daltons.

In yet another preferred embodiment of the present invention, at least one of the first and second reactants comprises at least approximately 1% of the gelled medium, more preferably at least approximately 1.5% of the gelled medium, and most preferably at least approximately 2.0% of the gelled medium.

The present invention is also directed to an electrochromic medium for use in an electrochromic device comprising: at least one solvent; an anodic electroactive material; a cathodic electroactive material; wherein at least one of the anodic and cathodic electroactive materials is electrochromic; a cross-linked polymer matrix; and means associated with the cross-linked polymer matrix for substantially diminishing undesirable visual irregularities and/or defects within the same.

In accordance with the present invention, an electrochromic device is disclosed which comprises: at least one substantially transparent substrate having an electrically conductive material associated therewith; and an electrochromic medium which comprises: at least one solvent; an anodic electroactive material; a cathodic electroactive material; wherein at least one of the anodic and cathodic electroactive materials is electrochromic; and a self-healing, cross-linked polymer matrix.

The present invention is further directed to an electrochromic device comprising: a first substantially transparent substrate having an electrically conductive material associated therewith; a second substrate having an electrically conductive material associated therewith; and an electrochromic medium contained within a chamber positioned between the first and second substrates which comprises: at least one solvent; an anodic electroactive material; a cathodic electroactive material; wherein at least one of the anodic and cathodic electroactive materials is electrochromic; and a self-healing, cross-linked polymer matrix.

### BRIEF DESCRIPTION OF THE DRAWINGS

The invention will now be described with reference to the drawings wherein:

FIG. 1 of the drawings is a cross-sectional, schematic representation of an electrochromic device fabricated in accordance with the present invention.

### DETAILED DESCRIPTION OF THE INVENTION

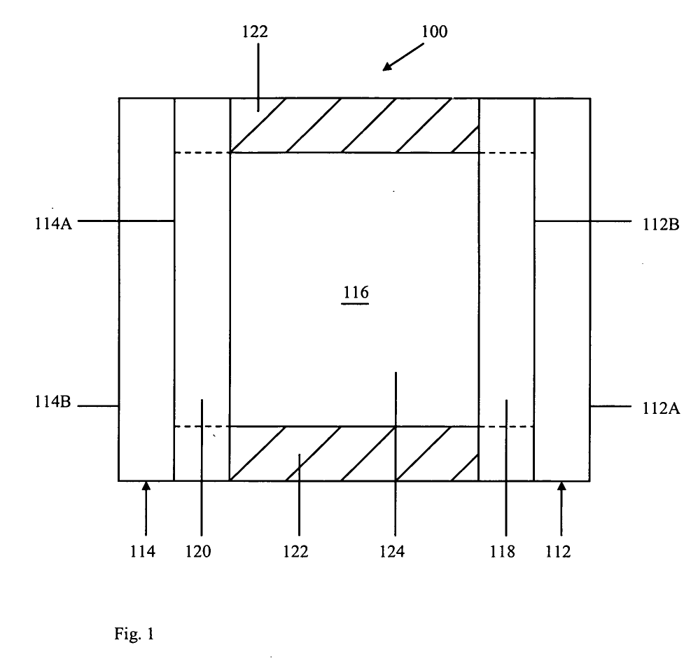

Referring now to FIG. 1 in particular, a cross-sectional schematic representation of electrochromic device 100 is shown, which generally comprises first substrate 112 having front surface 112A and rear surface 112B, second substrate 114 having front surface 114A and rear surface 114B, and chamber 116 for containing electrochromic medium 124. It will be understood that electrochromic device 100 may comprise, for illustrative purposes only, a mirror, a window, a transparency, a display device, a contrast enhancement filter, and the like. It will be further understood that FIG. 1 is merely a schematic representation of electrochromic device 100. As such, some of the components have been distorted from their actual scale for pictorial clarity. Indeed, numerous other electrochromic device configurations are contemplated for use, including those disclosed in U.S. Pat. No. 5,818,625 entitled “Electrochromic Rearview Mirror Incorporating A Third Surface Metal Reflector” and U.S. Pat. No. 6,597,489 entitled “Electrode Design For Electrochromic Devices,” all of which are hereby incorporated herein by reference in their entirety.

First substrate 112 may be fabricated from any one of a number of materials that are transparent or substantially transparent in the visible region of the electromagnetic spectrum, such as, for example, borosilicate glass, soda lime glass, float glass, natural and synthetic polymeric resins, plastics, and/or composites including Topas®, which is commercially available from Ticona of Summit, N.J. First substrate 112 is preferably fabricated from a sheet of glass having a thickness ranging from approximately 0.5 millimeters (mm) to approximately 12.7 mm, and more preferably less than approximately 1 mm for certain low weight applications. Of course, the thickness of the substrate will depend largely upon the particular application of the electrochromic device. While particular substrate materials have been disclosed, for illustrative purposes only, it will be understood that numerous other substrate materials are likewise contemplated for use—so long as the materials are at least substantially transparent and exhibit appropriate physical properties, such as strength to be able to operate effectively in conditions of intended use. Indeed, electrochromic devices in accordance with the present invention can be, during normal operation, exposed to extreme temperature variation, as well as substantial UV radiation emanating primarily from the sun.

Second substrate 114 may be fabricated from similar materials as that of first substrate 112. However, if the electrochromic device is a mirror, then the requisite of substantial transparency is not necessary. As such, second substrate 114 may, alternatively, comprise polymers, metals, glass, and ceramics—to name a few. Second substrate 114 is preferably fabricated from a sheet of glass having a thickness ranging from approximately 0.5 mm to approximately 12.7 mm, and more preferably less than approximately 1 mm for certain low weight applications. It will be understood that first and/or second substrates 112 and 114, respectively, can optionally be tempered, heat strengthened, and/or chemically strengthened, prior to or subsequent to being coated with layers of electrically conductive material (118 and 120).

One or more layers of electrically conductive material 118 are associated with rear surface 112B of first substrate 112. These layers serve as an electrode for the electrochromic device. Electrically conductive material 118 is desirably a material that: (a) is substantially transparent in the visible region of the electromagnetic spectrum; (b) bonds reasonably well to first substrate 112; (c) maintains this bond when associated with a sealing member; (d) is generally resistant to corrosion from materials contained within the electrochromic device or the atmosphere; and (e) exhibits minimal diffusion or specular reflectance as well as sufficient electrical conductance. It is contemplated that electrically conductive material 118 may be fabricated from fluorine doped tin oxide (FTO), for example TEC glass, which is commercially available from Libbey Owens-Ford-Co., of Toledo, Ohio, indium/tin oxide (ITO), doped zinc oxide or other materials known to those having ordinary skill in the art.

Electrically conductive material 120 is preferably associated with front surface 114A of second substrate 114, and is operatively bonded to electrically conductive material 118 by sealing member 122. As can be seen in FIG. 1, once bonded, sealing member 122 and the juxtaposed portions of electrically conductive materials 118 and 120 serve to define an inner peripheral geometry of chamber 116.

Electrically conductive material 120 may vary depending upon the intended use of the electrochromic device. For example, if the electrochromic device is a mirror, then the material may comprise a transparent conductive coating similar to electrically conductive material 118 (in which case a reflector is associated with rear surface 114B of second substrate 114). Alternatively, electrically conductive material 120 may comprise a layer of reflective material in accordance with the teachings of previously referenced and incorporated U.S. Pat. No. 5,818,625. In this case, electrically conductive material 120 is associated with front surface 114A of second substrate 114. Typical coatings for this type of reflector include chromium, ruthenium, rhodium, silver, silver alloys, combinations, and stacked layers thereof.

Sealing member 122 may comprise any material that is capable of being adhesively bonded to electrically conductive materials 118 and 120 to, in turn, seal chamber 116 so that electrochromic medium 124 does not inadvertently leak out of the chamber. As is shown in dashed lines in FIG. 1, it is also contemplated that the sealing member 122 extend all the way to rear surface 112B and front surface 114A of their respective substrates. In such an embodiment, the layers of electrically conductive material 118 and 120 may be partially removed where the sealing member 122 is positioned. If electrically conductive materials 118 and 120 are not associated with their respective substrates, then sealing member 122 preferably bonds well to glass. It will be understood that sealing member 122 can be fabricated from any one of a number of materials including, for example, those disclosed in U.S. Pat. No. 4,297,401 entitled “Liquid Crystal Display And Photopolymerizable Sealant Therefor;” U.S. Pat. No. 4,418,102 entitled “Liquid Crystal Displays Having Improved Hermetic Seal;” U.S. Pat. No. 4,695,490 entitled “Seal For Liquid Crystal Display;” U.S. Pat. No. 5,596,023 entitled “Sealing Material For Liquid Crystal Display Panel, And Liquid Crystal Display Panel Using It;” U.S. Pat. No. 5,596,024 entitled “Sealing Composition For Liquid Crystal;” and U.S. Pat. No. 6,157,480 entitled “Seal For Electrochromic Devices,” all of which are hereby incorporated herein by reference in their entirety.

For purposes of the present disclosure, electrochromic medium/gelled electrochromic medium 124 comprises at least one solvent, an anodic material, a cathodic material, and a cross-linked polymer matrix. As will be shown in the experiments provided herein, the cross-linked polymer matrices of the present invention are self-healing, and therefore enable electrochromic medium 124, and, in turn, electrochromic device 100 to operate in a wide range of temperatures without visual irregularities and/or defects within the electrochromic medium adversely affecting the device. It will be understood that regardless of its ordinary meaning, the term “self-healing” will be defined herein as: (1) the ability to substantially return to an initial state or condition prior to exposure to a dynamic thermal environment and/or the ability to resist the formation of visual irregularities and/or defects; or, alternatively, (2) satisfying the following inequality defined herein: f+2(log(r)/p)≧1.00.

Typically both of the anodic and cathodic materials are electroactive and at least one of them is electrochromic. It will be understood that regardless of its ordinary meaning, the term “electroactive” will be defined herein as a material that undergoes a modification in its oxidation state upon exposure to a particular electrical potential difference. Additionally, it will be understood that the term “electrochromic” will be defined herein, regardless of its ordinary meaning, as a material that exhibits a change in its extinction coefficient at one or more wavelengths upon exposure to a particular electrical potential difference.

Electrochromic medium 124 is preferably chosen from one of the following categories:

(1) Single-layer, single-phase:—The electrochromic medium may comprise a single-layer of material which may include small non-homogenous regions and includes solution-phase devices where a material may be contained in solution in the ionically conducting electrolyte which remains in solution in the electrolyte when electrochemically oxidized or reduced. Solution phase electroactive materials may be contained in the continuous solution-phase of a gel medium in accordance with the teachings of U.S. Pat. No. 5,928,572 entitled “Electrochromic Layer And Devices Comprising Same” and International Patent Application Serial No. PCT/US98/05570 entitled “Electrochromic Polymeric Solid Films, Manufacturing Electrochromic Devices Using Such Solid Films, And Processes For Making Such Solid Films And Devices,” both of which are hereby incorporated herein by reference in their entirety.

More than one anodic and cathodic material can be combined to give a pre-selected color as described in U.S. Pat. No. 6,020,987 entitled “Improved Electrochromic Medium Capable of Producing A Pre-Selected Color,” which is hereby incorporated herein by reference in its entirety.

The anodic and cathodic materials can be combined or linked by a bridging unit as described in International Patent Application Serial No. PCT/WO97/30134 entitled “Electrochromic System,” which is hereby incorporated herein by reference in its entirety.

It is also possible to link anodic materials or cathodic materials by similar methods. The concepts described in these applications/patents can further be combined to yield a variety of electroactive materials that are linked, including linking of a redox buffer to an anodic and/or cathodic material.

Additionally, a single-layer, single-phase medium may include a medium where the anodic and cathodic materials are incorporated into a polymer matrix as is described in International Patent Application Serial No. PCT/WO99/02621 entitled “Electrochromic Polymer System” and International Patent Application Serial No. PCT/US98/05570 entitled “Electrochromic Polymeric Solid Films, Manufacturing Electrochromic Devices Using Such Solid Films, And Processes For Making Such Solid Films And Devices,” which are hereby incorporated herein by reference in their entirety.

(2) Multi-layer—the medium may be made up in layers and includes a material attached directly to an electrically conducting electrode or confined in close proximity thereto which remains attached or confined when electrochemically oxidized or reduced. Examples of this type of electrochromic medium include a WO₃/ionically conducting layer/counter layer electrochromic medium. An organic or organometallic layer attached to the electrode may also be included in this type of medium.

(3) Multi-phase—one or more materials in the medium undergoes a change in phase during the operation of the device, for example a material contained in solution in the ionically conducting electrolyte forms a layer on the electrically conducting electrode when electrochemically oxidized or reduced.

The cathodic material may include, for example, viologens, such as methyl viologen tetrafluoroborate, octyl viologen tetrafluoroborate, or 1,1′,3,3′-tetramethyl-4,4′-bipyridinium tetrafluoroborate. It will be understood that the preparation and/or commercial availability for each of the above-identified cathodic materials is well known in the art. While specific cathodic materials have been provided, for illustrative purposes only, numerous other conventional cathodic materials are likewise contemplated for use including, but by no means limited to, those disclosed in U.S. Pat. No. 4,902,108, entitled “Single-Compartment, Self-Erasing, Solution-Phase Electrochromic Devices, Solutions For Use Therein, and Uses Thereof,” which is hereby incorporated herein by reference in its entirety. Indeed, the only contemplated limitation relative to the cathodic material is that it should not adversely affect the electrochromic performance of the device 100. Moreover, it is contemplated that the cathodic material may comprise a polymer film, such as polythiophenes, an inorganic film, such as Prussian Blue, or a solid transition metal oxide, including, but not limited to, tungsten oxide.

The anodic material may comprise any one of a number of materials including ferrocene, substituted ferrocenes, substituted ferrocenyl salts, substituted phenazines, phenothiazine, substituted phenothiazines, thianthrene, substituted thianthrenes. Examples of anodic materials may include di-tert-butyl-diethylferrocene, (6-(tetra-tert-butylferrocenyl)hexyl)triethylammonium tetrafluoroborate, (3-(tetra-tert-butylferrocenyl)propyl)triethylammonium tetrafluoroborate, 5,10-dihydro-5,10-dimethylphenazine, 3,7,10-trimethylphenothiazine, 2,3,7,8-tetramethoxythianthrene, and 10-methylphenothiazine. It is also contemplated that the anodic material may comprise a polymer film, such as polyaniline, polythiophenes, polymeric metallocenes, or a solid transition metal oxide, including, but not limited to, oxides of vanadium, nickel, iridium, as well as numerous heterocyclic compounds, etcetera. It will be understood that numerous other anodic materials are contemplated for use including those disclosed in the previously referenced and incorporated '108 patent, as well as U.S. Pat. No. 6,188,505 B1 entitled “Color-Stabilized Electrochromic Devices,” (color-stabilizing additives/redox buffers) which is hereby incorporated herein by reference in its entirety.

For illustrative purposes only, the concentration of the anodic and cathodic materials can range from approximately 1 mM to approximately 500 mM and more preferably from approximately 5 mM to approximately 50 mM. While particular concentrations of the anodic as well as cathodic materials have been provided, it will be understood that the desired concentration may vary greatly depending upon the geometric configuration of the chamber containing electrochromic medium 124.

For purposes of the present disclosure, the solvent of electrochromic medium 124 may comprise any one of a number of common, commercially available solvents including 3-methylsulfolane, glutaronitrile, dimethyl sulfoxide, dimethyl formamide, acetonitrile, tetraglyme and other polyethers, alcohols such as ethoxyethanol, nitriles, such as 3-hydroxypropionitrile, 2-methylglutaronitrile, ketones including 2-acetylbutyrolactone, cyclopentanone, cyclic esters including beta-propiolactone, gamma-butyrolactone, gamma-valerolactone, cyclic carbonates including propylene carbonate, ethylene carbonate and homogenous mixtures of the same. While specific solvents have been disclosed as being associated with the electrochromic medium, numerous other solvents or plasticizers that would be known to those having ordinary skill in the art having the present disclosure before them are likewise contemplated for use.

In accordance with the present invention, electrochromic medium/gelled electrochromic medium 124 comprises a cross-linked polymer matrix. The cross-linked polymer matrix includes a backbone which may be selected from, for example, polyamides, polyimides, polycarbonates, polyesters, polyethers, polymethacrylates, polyacrylates, polysilanes, polysiloxanes, polyvinylacetates, polymethacrylonitriles, polyacrylonitriles, polyvinylphenols, polyvinylalcohols, polyvinylidenehalides, and co-polymers and combinations thereof.

For purposes of the present disclosure, adhesive/cohesive functional groups are associated with and/or incorporated into the polymer backbone, and may include a hydroxyl group, thiols, amines, amides, carboxylic acids, carboxylates, phosphonates, sulfonyl halides, silicate esters, ammonium salts, sulfonyl acids, siloxyls, silyls, cyanos, and combinations thereof. Unlike conventional cross-linked polymer matrices used in electrochromic devices, the cross-linked polymer matrices of the present invention preferably include one or more of the above-identified adhesive/cohesive functional groups which are present in an effective concentration to substantially diminish and/or eliminate visual irregularities and/or defects within the electrochromic medium. It will be understood that the term “cohesive” will be defined herein, regardless of its ordinary meaning, as attractive forces within a polymer network itself, and/or attractive forces between a cross-linked polymer backbone and an associated solvent within a polymer network (i.e. solvation). It will be further understood that the term “adhesive” will be defined herein, regardless of its ordinary meaning, as attractive forces between a polymer network and the surface of an associated substrate and/or electrically conductive material.

In accordance with the present invention, the above-identified polymer backbones are preferably cross-linked with a cross-linking (i.e. second) reactant having a cross-linking functional group, such as an isocyanate. While an isocyanate has been disclosed, for illustrative purposes only, as a cross-linking functional group, it will be understood that any one of a number of other cross-linking functional groups that would be known to those with ordinary skill in the art having the present disclosure before them are likewise contemplated for use—with the only limitation being that for the cross-linked polymer matrix to be self-healing, an adhesive/cohesive functional group must be present in an effective concentration to substantially diminish and/or eliminate visual irregularities and/or defects within the electrochromic medium or, alternatively, satisfy the following inequality defined herein f+2(log(r)/p)≧1.00. However, as will be shown in the experiments provided herein below, the molar ratio of the adhesive/cohesive functional group on the polymer backbone to the cross-linking functional group (as measured by reactant concentration) is preferably greater than approximately 3:1, and more preferably between approximately 3:1 and approximately 100:1. As will be shown in the experiments provided herein below, when the cross-linked polymer matrix comprises an effective concentration of adhesive/cohesive functional groups relative to cross-linking functional groups, the gelled electrochromic medium exhibits remarkable self-healing characteristics unseen heretofore.

In further accordance with an embodiment of the present invention, and as will be shown in the experiments provided herein below, it has now been surprisingly discovered that the cross-linked polymer matrix, which comprises a product of a first reactant having an adhesive/cohesive functional group and/or a cross-linking functional group and/or a second reactant having a cross-linking functional group, is “self-healing” when the following inequality is satisfied:
f+2(log(r)/p)≧1.00
wherein f (i.e. calculated flexibility) comprises Σ_{x/m}; wherein x comprises a value ranging from 0 to 2 for each element (A), aryl moiety (Ar), and cyclic moiety (Cy) of at least one of the first and second reactants; wherein x comprises 0 if A or Ar is represented by one of the following structures: 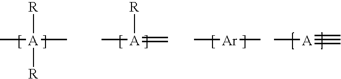
wherein x comprises 0.5 if A or Cy is represented by one of the following structures: 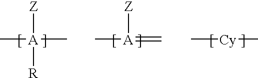
wherein x comprises 1.0 if A is represented by one of the following structures: 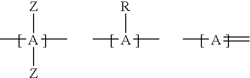
wherein x comprises 1.5 if A is represented by the following structure: 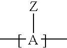
wherein x comprises 2.0 if A is represented by the following structure: 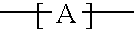
wherein A comprises C, N, O, S, P, or Si; wherein Z comprises H or F; wherein R comprises any other pendent group other than Z; wherein m comprises the number of (A) elements, (Ar) moieties, and (Cy) moieties of the at least one of the first and second reactants which define x; wherein r comprises the molar ratio of the adhesive/cohesive functional group of the first reactant to the cross-linking functional group of the first and/or second reactant(s); and wherein p comprises the total concentration by weight of the self-healing, cross-linked polymer matrix in the gelled electrochromic medium.

It will be understood that if (A), (Ar) and/or (Cy) comprises an element and/or moiety not expressly provided within the above-identified structures, then x will comprise a value of 0.

For purposes of eliminating any ambiguity associated with determining f, examples of calculated flexibility are provided herein below:

### Poly(methyl methacrylate)

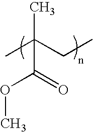

Poly(methyl methacrylate) has two pendent groups on each carbon atom along the polymer backbone, alternating between methyl and a methyl ester on one carbon atom (x=0) and two hydrogen atoms on the other carbon atom (x=1). The calculated flexibility, f, of poly(methyl methacrylate) is the average of all the x-values along the backbone, which is 0.50.

### 1/5 Copolymer of 2-hydroxyethyl acrylate and methyl methacrylate

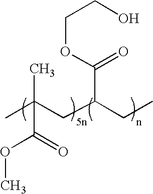

The 2-hydroxyethyl acrylate repeat unit has carbon atoms in the backbone that have x-values of 0.5 and 1, while the methyl methacrylate repeat unit has carbon atoms in the backbone that have x-values of 0 and 1. Since there are 5 methyl methacrylate repeat units for every one 2-hydroxyethyl acrylate repeat unit, the contribution of the methyl methacrylate to the overall flexibility of the prepolymer is five times greater than the 2-hydroxyethyl acrylate repeat unit. The calculated flexibility, f, of a 1/5 copolymer of 2-hydroxyethyl acrylate and methyl methacrylate is 0.54, which is only slightly more flexible than the previous example of poly(methyl methacrylate).

### 1/1 Copolymer of ethylene glycol and propylene glycol

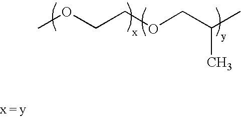

The oxygen atom in the prepolymer backbone has an x-value of 2, the methylene groups in the prepolymer backbone have an x-value of 1, and the methyl substituted carbon atom in the prepolymer backbone has an x-value of 0.5. The calculated flexibility, f, of a 1/1 copolymer of ethylene glycol and propylene glycol is 1.25.

### Polycaprolactone

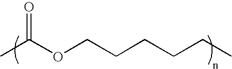

The five methylene carbon atoms and the carbonyl carbon atoms in the prepolymer repeat unit each have x-values of 1, while the oxygen atom in the prepolymer backbone has an x-value of 2. The calculated flexibility, f, of a polycaprolactone is 1.14.

### Linear polybutadiene

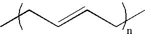

The two carbon atoms in the backbone are saturated (x=1) and the two carbon atoms in the prepolymer backbone have a double bond to an adjacent carbon (x=0.5). The calculated flexibility, f, of a linear polybutadiene is 0.75.

### Poly (phenylene ether-ether-sulfone)

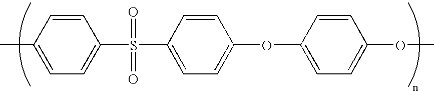

The repeat unit for this polymer has three aromatic rings (x=0), two ether linkages (x=2), and one sulfone group (x=0). The calculated flexibility, f, of poly (phenylene ether-ether-sulfone) is 0.67.

Another example is a 1/5 copolymer of 2-hydroxyethyl acrylate and methyl methacrylate that has been crosslinked with 2,4-toluene diisocyanate (TDI). In this example, enough TDI was added to the copolymer to react with ½ of the free hydroxyls in the copolymer (as shown below).

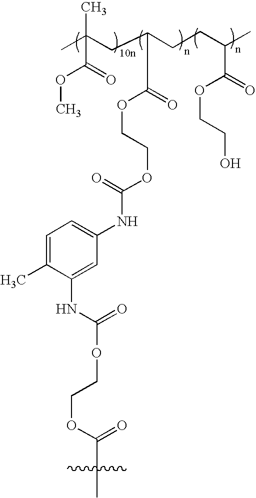

In this case, the molar ratio of hydroxyl groups to isocyanate groups is 2:1. Since the reacted TDI is now part of the polymer matrix backbone, its backbone structure plus the portion of the copolymer that is involved in the reaction with the TDI must be calculated into the flexibility of the polymer matrix. The 2-hydroxyethyl acrylate repeat unit would have carbons in the backbone that have x-values of ½ and 1, while the methyl methacrylate repeat would have carbons in the backbone that have x-values of 0 and 1. Since there are 5 methyl methacrylate repeat units for every one 2-hydroxyethyl acrylate repeat unit, the contribution of the methyl methacrylate to the overall flexibility of the copolymer would be five times greater than the 2-hydroxyethyl acrylate repeat unit. For each TDI that has reacted with the copolymer, there is one repeat that has an x-value of 0, eight repeats that have x-value of 1, two repeats that have x-value of 1.5, and four repeats that have x-values of 2. On a molar ratio basis, a 1/5 copolymer of 2-hydroxyethyl acrylate and methyl methacrylate that has half of the hydroxyl groups reacted with the TDI, the calculated flexibility (f) is 0.82.

The above-identified examples of calculated flexibility, f, are not intended to be exhaustive, but rather illustrative in scope.

It will be understood that, in accordance with one embodiment of the present invention, the average molecular weight of at least one of the first and second reactants is greater than approximately 2,000 daltons, more preferably greater than approximately 5,000 daltons, and most preferably greater than approximately 10,000 daltons.

It will be further understood that, in accordance with one embodiment of the present invention, at least one of the first and second reactants comprises at least approximately 1% of the gelled medium, more preferably at least approximately 1.5% of the gelled medium, and most preferably at least approximately 2.0% of the gelled medium.

In addition, electrochromic medium 124 may comprise other materials, such as light absorbers, light (e.g. UV) stabilizers, thermal stabilizers, antioxidants, tint providing agents, and mixtures thereof. Suitable UV-stabilizers may include: the material ethyl-2-cyano-3,3-diphenyl acrylate, sold by BASF of Parsippany, N.Y., under the trademark Uvinul N-35 and by Aceto Corp., of Flushing, N.Y., under the trademark Viosorb 910; the material (2-ethylhexyl)-2-cyano-3,3-diphenyl acrylate, sold by BASF under the trademark Uvinul N-539; the material 2-(2′-hydroxy-4′-methylphenyl)benzotriazole, sold by Ciba-Geigy Corp. under the trademark Tinuvin P; the material 3-[3-(2H-benzotriazole-2-yl)-5-(1,1-dimethylethyl)-4-hydroxyphenyl]-propionic acid pentyl ester prepared from Tinuvin 213, sold by Ciba-Geigy Corp., via conventional hydrolysis followed by conventional esterification (hereinafter “Tinuvin PE”); the material 2,4-dihydroxybenzophenone sold by, among many others, Aldrich Chemical Co.; the material 2-hydroxy-4-methoxybenzophenone sold by American Cyanamid under the trademark Cyasorb UV 9; and the material 2-ethyl-2′-ethoxyalanilide sold by Sandoz Color & Chemicals under the trademark Sanduvor VSU—to name a few.

Electrochromic devices having as a component part an electrochromic medium comprising a self-healing, cross-linked polymer matrix can be used in a wide variety of applications wherein the transmitted or reflected light can be modulated. Such devices include rear-view mirrors for vehicles; windows for the exterior of a building, home or vehicle including aircraft transparencies; skylights for buildings including tubular light filters; windows in office or room partitions; display devices; contrast enhancement filters for displays; and light filters for photographic devices and light sensors—just to name a few.

In support of the present invention, several experiments were conducted wherein electrochromic devices were prepared and subsequently tested for, among other things, visual irregularities under highly dynamic thermal conditions. In particular, each one of the electrochromic devices included a first (2.5″×10″) substrate coated with generally clear, conductive indium/tin oxide (ITO) on the rear surface (112B), and a second (2.5″×10″) substrate coated with a conventional conductive metal reflector on the front surface (114A), with the exception that the devices of Experiment No. 2 were coated with fluorine-doped tin oxide on surfaces 112B, 114A and a metal reflector was associated with surface 114B. The two substrates were spaced 137 microns apart for accommodating the medium. In each experiment the electrochromic devices were placed in an oven that was pre-heated to approximately 85° C. The devices were then left in the oven for between approximately 16 and approximately 64 hours. Next, the electrochromic devices were removed from the oven, visually inspected, and immediately placed into a freezer having a temperature set point of approximately −40° C. The electrochromic devices remained in the freezer for between approximately 6 and approximately 8 hours. Each of the devices were then inspected for visual irregularities, and immediately placed back into the above-identified, pre-heated oven for a second cycle. The electrochromic devices of the present invention were each thermally cycled 14 times—with the last cycle concluding with a warm up to ambient temperature for approximately 14 hours. After warming to ambient temperature, the devices were inspected for, among other things, visual irregularities and/or defects. The above-identified procedure and derivatives thereof may be referred to as thermal shock testing. It will be understood that the term “cycle” will be herein defined relative to the experimental procedure as exposure from hot to cold or vice versa.

### Experiment No. 1

It will be understood that in the experiments provided herein below, all concentrations and percentages are by weight unless otherwise indicated. The following is an example of an electrochromic polyacrylate gel having a large excess of hydroxyl groups in the polymer matrix. The ratio of hydroxyl to isocyanate was circa 13 to 1 and the total concentration of copolymer and HDT in the electrochromic gel was 3%.

The electrochromic gel was made by a two-solution technique. The first solution was made by mixing 0.6892 g of a 5% (by weight) solution of HDT (a trimer of hexamethylenediisocyanate) in propylene carbonate (PC) and 0.665 g of 1,1′-dioctyl-4,4′-dipyridinium tetrafluoroborate. The second solution was made by mixing 24.2 g of PC, 0.181 g of 5,10-dihydro-5,10-dimethylphenazine, 3.49 g of Viosorb 910, and 8.180 g of a 13.3% stock solution of a 4:1 poly(methylacrylate-co-2-hydroxyethylacrylate) in PC. The two solutions were mixed together with 0.0444 g of a 1% solution of dibutyltin diacetate in PC and backfilled into electrochromic devices. The devices were baked in a 60° C. oven overnight (circa 16 hours) to gel the electrochromic material.

The stock polyacrylate resin was made in the following manner: 71.7 g (0.833 mol) of methylacrylate, 24.2 g (0.208 mol) of 2-hydroxyethylacrylate, 0.627 g of an azothermal initiator (V-601) (dimethyl 2,2′-axobis(2-methypropionate), Wako Chemicals USA, Inc., Richmond, Va., U.S.A.), and 624 g of PC were added to a three-neck round bottom flask and heated to 70° C. while stirring under a nitrogen atmosphere for circa 20 hours. Next, 0.235 g of initiator, V-601, was added to the solution and the flask was heated to circa 150° C. for 1.5 hours while stirring under a nitrogen atmosphere. GPC analysis using polystyrene secondary standards indicated that the polymer formed had a number average molecular weight (Mₙ) of 34,000 g/mol and a weight average molecular weight (M_{w}) of 81,000 g/mol.

Thermal shock observations of these electrochromic devices were as follows: more than half of the devices showed signs of either bubbles and/or hairline voids, commonly referred to as “wormholes”, after being put in −40° C. during most of the thermal shock cycles. All of the devices healed completely, with no visible signs of defects in the electrochromic material after the devices had completed all of the thermal shock cycles and were allowed to warm to room temperature.

In accordance with the preferred inequality of the present invention, identified herein as f+2(log(r)/p)≧1.00, the data from Experiment 1 demonstrates that 0.794+2(log(13)/3)=1.54>1.00. Therefore, based on the foregoing inequality, the cross-linked polymer matrix of Experiment No. 1 is self-healing which comports with the above-identified observations.

### Experiment No. 2

The following is an example of an electrochromic polyacrylate gel that had a moderate excess of hydroxyl groups in the polymer matrix. The ratio of hydroxyl to isocyanate was circa 4 to 1 and the total concentration of copolymer and HDT in the electrochromic gel was 6.0%.

The electrochromic gel was made by a two-solution technique. The first solution was made by mixing 2.278 g of a 5% (by weight) solution of HDT in PC and 0.615 g of 1,1′-dioctyl-4,4′-dipyridinium tetrafluoroborate. The second solution was made by mixing 18.95 g of PC, 0.195 g of 5,10-dihydro-5,10-dimethylphenazine, 2.87 g of Viosorb 910, and 16.11 g of a 14.6% stock solution of a 10:1 poly(methylacrylate-co-2-hydroxyethylacrylate) in PC. GPC analysis using polystyrene secondary standards indicated that the polymer had a number average molecular weight (Mₙ) of 19,000 g/mol and a weight average molecular weight (M_{w}) of 108,000 g/mol. The two solutions were mixed together with 0.0296 g of a 10% solution of dibutyltin diacetate in PC and backfilled into electrochromic devices. The devices were baked in an 80° C. oven overnight (circa 16 hours) to gel the electrochromic material.

Thermal shock observations of these electrochromic devices were as follows for the six parts tested: one showed no signs of any bubbles and/or wormholes during any of the thermal shock cycles; one device had one occurrence of either a wormhole and/or bubble, one device had three occurrences of either a wormhole and/or bubble, and three devices had occurrences on most cycles of either a wormhole and/or bubble. All of the devices healed completely upon completion of the test, except one device that had a small residual bubble after 17 hours.

In accordance with the preferred inequality of the present invention, identified herein as f+2(log(r)/p)≧1.00, the data from Experiment 2 demonstrates that 0.812+2(log(4)/6)=1.01>1.00. Therefore, based on the foregoing inequality, the cross-linked polymer matrix of Experiment No. 2 is self-healing which comports with the above-identified observations.

### Experiment No. 3

The following is an example of an electrochromic polyacrylate gel that had a slight excess of hydroxyl groups in the polymer matrix. The ratio of hydroxyl to isocyanate was circa 1.1 to 1 and the total concentration of copolymer and bisphenol A in the electrochromic gel was 4%.

The electrochromic gel was made by a two-solution technique. The first solution was made by mixing 36.61 g of propylene carbonate (PC), 0.0774 g of bisphenol A (the hydroxyl crosslinker), 5.12 g of Viosorb 910, and 0.260 g of 5,10-dihydro-5,10-dimethylphenazine. The second solution was made by mixing 0.978 g of 1,1′-dioctyl-4,4′-dipyridinium tetrafluoroborate and 11.95 g of a 18.4% solution of a poly-(methylacrylate-co-2-isocyanoethylmethacrylate) in PC. GPC analysis using polystyrene secondary standards indicated that the polymer had a number average molecular weight (Mₙ) of 17,000 g/mol and a weight average molecular weight (M_{w}) of 121,000 g/mol. The ratio of methylacrylate to 2-isocyanoethylmethacrylate in the copolymer resin was 40 to 1. The two solutions as well as 0.110 g of a 1% solution of dibutyltin dilaurate in PC were mixed together, backfilled into electrochromic devices, and placed into a 40-50° C. oven. The electrochromic devices were gelled in four days.

Thermal shock observations for a set of eight of these devices were as follows: signs of bubbles and/or wormholes were observed in all of the devices after being put in a −40° C. freezer during one to three cycles. After allowing these devices to warm to room temperature at the end of the last cycle, all of them had signs of very light defects that looked like small wrinkles. There was also light to very light defects that became more apparent on coloring and clearing in all of the devices.

In accordance with the preferred inequality of the present invention, identified herein as f+2(log(r)/p)≧1.00, the data from Experiment 3 demonstrates that 0.782+2(log(1.1)/4)=0.803<1.00. Therefore, based on the foregoing inequality, the cross-linked polymer matrix of Experiment No. 3 is not self-healing which comports with the above-identified observations.

### Experiment No. 4

The following is an example of a polyacrylate gel that is crosslinked with a poly(ethylene glycol) diol. The total concentration of polyacrylate and poly(ethylene glycol) diol in the gel was 5%. This polymer matrix had a hydroxyl to isocyanate ratio of 1.1 to 1. This is an example of a gel that had a slight excess of hydroxyl functionality.

The following example was made by a two-solution technique. The first solution was made by mixing 11.13 g of a 18.42% 1:40 poly(2-isocyanoethylmethacrylate-co-methylacrylate) solution in PC. GPC analysis using polystyrene secondary standards indicated that the polymer had a number average molecular weight (Mₙ) of 17,000 g/mol and a weight average molecular weight (M_{w}) of 121,000 g/mol with 0.837 g of 1,1′-dioctyl-4,4′-dipyridinium tetrafluoroborate. The second solution was made by mixing 30.34 g of PC, 0.222 g of 5,10-dihydro-5,10-dimethylphenazine, 4.43 g of Viosorb 910, and 0.326 g of poly(ethylene glycol) MW=1000 g/mol (Aldrich). The two solutions were mixed together with 0.0451 g of a 1% solution of dibutyltin diacetate in PC and backfilled into electrochromic devices. The devices were baked in a 60° C. oven overnight (circa 16 hours) to gel the electrochromic material.

Thermal shock observations for a set of six parts were as follows: signs of bubbles and/or wormholes were observed after being put into a −40° C. freezer approximately seven times for half of the devices. After allowing the devices to warm to room temperature at the end of the last cycle, all showed signs of very light defects. These defects were most noticeable on coloring and clearing of the devices.

In accordance with the preferred inequality of the present invention, identified herein as f+2(log(r)/p)≧1.00, the data from Experiment 4 demonstrates that 0.954+2(log(1.1)/5)=0.971<1.00. Therefore, based on the foregoing inequality, the cross-linked polymer matrix of Experiment No. 4 is not self-healing which comports with the above-identified observations.

### Experiment No. 5

In this experiment an electrochromic polyacrylate-polyether gel was prepared, wherein an excess of hydroxyl groups was present in the gel. The molar ratio of hydroxyl groups to isocyanate groups for this experiment was approximately 10:1. The total concentration of polymer and HDT crosslinker in the gel was 5.4%.

The polymer gel was prepared by the following two-solution technique. The first solution was made by mixing 1.54 g of a 5% (by weight) solution of Tolonate HDT in PC and 0.819 g of 1,1′-dioctyl-4,4′-dipyridinium tetrafluroborate. The second solution was prepared by mixing 21.3 g PC, 0.219 g 5,10-dihydro-5,10-dimethylphenazine, 4.29 g Viosorb 910, 18.0 g of a 12.4% solution of a terpolymer polyol in PC, and 0.054 g of a 1% solution of dibutyltin diacetate in PC. The terpolymer polyol was synthesized from methylacrylate, 2-hydroxylethylacylate, and poly(ethylene glycol) monomethyl ether monomethacrylate (molecular weight circa 1000 g/mol, Aldrich) via a thermal initiated radical polymerization with molar ratios of 18, 6 and 1 respectively. GPC analysis using polystyrene secondary standards indicated that the polymer formed had a number average molecular weight (Mₙ) of 14,000 g/mol and a weight average molecular weight (M_{w}) of 18,000 g/mol. The two solutions were mixed together and backfilled into eight electrochromic devices. The devices were allowed to gel over the next four days at ambient temperature. One part was split open to ensure gelation had occurred. Thermal shock testing was done on six devices.

Thermal shock observations of these electrochromic devices were as follows: all of the devices showed wormholes on most of the cycles. All of the devices healed completely upon completion of the test, with the exception of one device which had small, pin-sized dots near the side of the device where it had been filled.

In accordance with the preferred inequality of the present invention, identified herein as f+2(log(r)/p)≧1.00, the data from Experiment 5 demonstrates that 0.806+2(log(10)/5.4)=1.18>1.00. Therefore, based on the foregoing inequality, the cross-linked polymer matrix of Experiment No. 5 is self-healing which comports with the above-identified observations.

### Experiment No. 6

In this experiment, a polymer gel was made from the addition of a hydroxy functional crosslinker to a terpolymer of methylacrylate, methacrylonitrile, and 2-isocyanoethylmethacrylate. The molar ratio of hydroxyl groups to isocyanate groups for this experiment was approximately 1.1 to 1. It will be understood that for every equivalent of an isocyanate there are 4.28 equivalents of cyano groups in the co-polymer. The concentration of terpolymer and crosslinker in the gel was approximately 7.0%.

The stock terpolymer solution was made in the following manner: 20.8 g (0.309 mol) of methacrylonitrile (MAN), 77.4 g (0.733 mol) of methyl methacrylate (MMA), 12.0 g (0.0733 mol) of 2-isocyanoethylmethacrylate (IEMA), and 1.33 g of a thermal initiator (V-601, dimethyl 2,2′-azobis(2-methylpropionate), Wako Chemicals USA, Inc., Richmond, Va., U.S.A.) were placed in an addition funnel that was attached to a three-neck round bottom flask that was charged with 720 g of propylene carbonate (PC). The flask was heated to a temperature between 70 and 80° C. with agitation under a nitrogen atmosphere. The contents of the addition funnel were slowly dripped into the PC over a 1 hour period. The flask was heated to a temperature between 60 and 70° C. for approximately 16 hours, then 0.103 g of the thermal initiator V-601 was added to the solution to react with any unreacted monomer.

The polymer gel was prepared by the following two-solution technique. The first solution was made by mixing 0.929 g of 1,1′-dioctyl-4,4′-dipyridinium tetrafluoroborate with 25.6 g of the stock terpolymer stock solution. The second solution was prepared by mixing 20.3 g of PC, 0.249 g of 5,10-dihydro-5,10-dimethylphenazine, 4.87 g of Viosorb 910, and 0.300 g of bisphenol A. The two solutions were mixed together and backfilled into ten electrochromic devices. The devices were allowed to gel over the next two days at ambient temperature. Two parts were split open to ensure gelation had occurred. Thermal shock testing was done on seven devices.

Thermal shock observations of these electrochromic devices were as follows: only one device showed a wormhole after one cycle. Upon completion of the test, all of the devices had visible wrinkle defects.

In accordance with the preferred inequality of the present invention, identified herein as f+2(log(r)/p)≧1.00, the data from Experiment 6 demonstrates that 0.641+2(log(5.38)/7)=0.850<1.00. Therefore, based on the foregoing inequality, the cross-linked polymer matrix of Experiment No. 6 is not self-healing which comports with the above-identified observations.

### Experiment No. 7

In this experiment, a polymer gel was made from the addition of 2,4-toluene diisocyanate (TDI) to a copolymer of methyl methacrylate and 2-hydroxyethyl methacrylate. The molar ratio of hydroxyl groups to isocyanate groups for this experiment was approximately 2:1. This example has 7.1% by weight of an isocyanate crosslinker and polymer.

The stock terpolymer resin was made in the following manner: 100.0 g (0.999 mol) of methyl methacrylate (MMA), 13.0 g (0.0999 mol) of 2-hydroxyethyl methacrylate (HEMA), and 452 g of propylene carbonate (PC) were placed in a round bottom flask, heated to a temperature 70° C. with agitation under a nitrogen atmosphere. Once the desired temperature was reached, 0.0960 g of a thermal initiator (V-601, dimethyl 2,2′-azobis(2-methylpropionate), Wako Chemicals USA, Inc., Richmond, Va., U.S.A.) was dissolved in 7.26 g of PC and added to the reaction mixture. After 1.5 hours, the reaction mixture showed signs of thickening. The flask was heated for approximately 16 additional hours at 70° C. The polymer solution was then diluted with 565 g of PC to make a 10% by weight polymer solution. GPC analysis was done on the polymer using polystyrene standards and tetrahydrofuran as a mobile phase. The analysis indicated that the polymer formed had a number average molecular weight (Mₙ) of 327,000 g/mol and a weight average molecular weight (M_{w}) of 485,000 g/mol.

The polymer gel was prepared by mixing 2.29 g of 1,1′-bis(3-phenyl(n-propyl)-4,4′-bipyridinium tetrafluoroborate, 0.697 g of 5,10-dihydro-5,10-dimethylphenazine, 0.799 g of Tinuvin P, 42.0 g of PC, 0.383 g of TDI and 100 g of the stock copolymer solution. The solution was backfilled into eleven electrochromic devices. The devices were allowed to gel over the next two days in a 70° C. oven. Two parts were split open to ensure gelation had occurred. Thermal shock testing was done on nine devices.

Thermal shock observations for a set of nine parts were as follows: wormholes were observed after being put into a −40° C. freezer for every device on all of the 14 cycles. After allowing the devices to warm to room temperature at the end of the last cycle, all showed signs of hair line defects, most noticeably in a two centimeter strip along the outer circumference of the device. In addition, two of the devices had wormholes that did not completely close and were yellowish in color. The yellow color is indicative of an oxygen contamination, possibly due to the epoxy seal losing partial adhesion.

In accordance with the preferred inequality of the present invention, identified herein as f+2(log(r)/p)≧1.00, the data from Experiment 7 demonstrates that 0.611+2(log(2)/7.1)=0.696<1.00. Therefore, based on the foregoing inequality, the cross-linked polymer matrix of Experiment No. 7 is not self-healing which comports with the above-identified observations.

### Experiment No. 8

In this experiment, an electrochromic gel was made from a polyethylene glycol diol and an isocyanate crosslinker. The molar ratio of hydroxyl groups to isocyanate groups for this experiment was approximately 1:1. The total concentration of polyether and HDT in the electrochromic gel was 8%.

The polymer gel was prepared by the following two-solution technique. The first solution was made by mixing 0.855 g of 1,1′-dioctyl-4,4′-dipyridinium tetrafluoroborate, 0.388 g of HDT (a trimer of hexamethylenediisocyanate), and 5.22 g of PC. The second solution was prepared be mixing 17.9 g of PC, 0.231 g of 5,10-dihydro-5,10-dimethylphenazine, 4.47 g of Viosorb 910, 0.062 g of a 1% by weight solution of dibutyltin diacetate in PC and 19.3 g of a 18.1% solution of polyethylene glycol polyol (molecular weight of circa 3400 g/mol, Aldrich) in PC. The two solutions were mixed together and backfilled into eight electrochromic devices. The devices were placed in a 60° C. oven for approximately 3 days. Two parts were split open to ensure gelation. It was observed that when splitting the parts open, which is the process of pulling the front and the back glass plates apart, this electrochromic gel was very adhesive, making this process difficult. Thermal shock testing was done on six devices.

Thermal shock observations of these electrochromic devices were as follows: all of the devices showed signs of wormholes after being put in −40° C., an average of three cycles. All of the devices healed completely, with no visible signs of defects in the electrochromic material after the devices had completed all of the thermal shock cycles and allowed to warm to room temperature.

In accordance with the preferred inequality of the present invention, identified herein as f+2(log(r)/p)≧1.00, the data from Experiment 8 demonstrates that 1.31+2(log(1)/8)=1.31>1.00. Therefore, based on the foregoing inequality, the cross-linked polymer matrix of Experiment No. 8 is self-healing which comports with the above-identified observations.

### Experiment No. 9

The following example is a 6% polymethacrylate gel that has a hydroxyl to isocyanate ratio of 16 to 1. This polymer gel device is an example of a device that has a large excess of hydroxyl groups, with a less flexible polymer backbone making up the polymer matrix.

For this example, two different stock copolymer resins were made. The first copolymer resin was made from monomers 2-hydroxypropylmethacrylate (HPMA) and methyl methacrylate (MMA) at 1 to 3 molar ratio respectively. This resin was polymerized in the following manner: 44.9 g (0.312 mol) of HPMA, 93.6 g (0.935 mol) of MMA, and 0.287 g of a thermal initiator (V-601, dimethyl-2,2′-azobis(2-methylpropionate), Wako Chemicals USA, Inc., Richmond, Va., U.S.A.) were placed in an addition funnel that was attached to a three-neck round bottom flask that was charged with 320 g of propylene carbonate (PC). The flask was heated to a temperature of approximately 130° C. with agitation under a nitrogen atmosphere. The contents of the addition funnel were slowly dripped into the PC over a 1 hour period. The reaction flask temperature was maintained at approximately 130° C. for 1.5 hours, and then 0.075 g of the thermal initiator V-601 dissolved in 5.72 g of PC was added to the solution. The flask was then heated for an additional 1 hour at 130° C. Then 0.057 g of V-601 dissolved in 6.69 g of PC were added, and the flask was heated an additional 1 hour at approximately 130° C. The reaction flask was then equipped with a Dean-Stark tube and the reaction mixture was heated to approximately 180° C. for 1 hour to strip off any unreacted monomer. The polymer solution was diluted with PC to make the final weight percent of polymer 23.5%. GPC analysis, using polystyrene standards and a tetrahydrofuran (THF) as a mobile phase, indicated that the polymer had a number average molecular weight (Mₙ) of 51,800 g/mol and a weight average molecular weight (M_{w}) of 115,000 g/mol. The second copolymer resin was made in a similar manner in PC from monomers 2-isocyanoethylethyl methacrylate (IEMA) and methyl methacrylate (MMA) at a molar ratio of 1 to 13.3, respectively. The final concentration of the copolymer in PC was approximately 26.2% by weight. GPC analysis of this polymer, using polystyrene standards and THF as a mobile phase, indicated that the polymer had a number average molecular weight (Mₙ) of 21,800 g/mol and a weight average molecular weight (M_{w}) of 54,500 g/mol.

The polymer gel was prepared by the following two-solution technique. The first solution was made by mixing 1.06 g of 1,1′-dioctyl-4,4′-dipyridinium tetrafluoroborate, 7.25 g of PC, and 2.57 g of the IEMA/MMA copolymer stock resin. The second solution was prepared by mixing 30.7 g of PC, 0.286 g of 5,10-dihydro-5,10-dimethylphenazine, 5.59 g of Viosorb 910, and 12.5 g of the HPMA/MMA copolymer stock resin. The two solutions were mixed together with 0.045 g of a 1% solution of dibutyltin dilaurate in PC and backfilled into ten electrochromic devices. The devices were allowed to gel over the next three days in a 70° C. oven. One part was split open to ensure gelation had occurred. Thermal shock testing was done on nine devices.

Thermal shock observations of these electrochromic devices were as follows: all nine devices formed wormholes and showed wrinkle defects on almost every cycle. Upon completion of the test, two of the nine devices completely healed, one had small dot defects, two had small segment defects, and four had moderate segment defects.

In accordance with the preferred inequality of the present invention, identified herein as f+2(log(r)/p)≧1.00, the data from Experiment 9 demonstrates that 0.561+2(log(16)/6)=0.962<1.00. Therefore, based on the foregoing inequality, the cross-linked polymer matrix of Experiment No. 9 is not self-healing which comports with the above-identified observations.

### Experiment No. 10

In this experiment, an electrochromic gel was made from the addition of 2,4-toluene diisocyanate (TDI) to a copolymer of methyl methacrylate and 2-hydroxyethyl methacrylate. The molar ratio of hydroxyl groups to isocyanate groups for this experiment was approximately 2:1. This example has 7.1% by weight of an isocyanate crosslinker and polymer.

The stock copolymer resin was made in the following manner: 100.0 g (0.999 mol) of methyl methacrylate (MMA), 13.0 g (0.0999 mol) of 2-hydroxyethyl methacrylate (HEMA), and 452 g of propylene carbonate (PC) were placed in a round bottom flask, heated to a temperature of 70° C. with agitation under a nitrogen atmosphere. Once the desired temperature was reached, 0.0960 g of a thermal initiator (V-601, dimethyl 2,2′-azobis(2-mehtylpropionate), Wako Chemicals USA, Inc., Richmond, Va., U.S.A.) was dissolved in 7.26 g of PC and added to the reaction mixture. After 1.5 hours, the reaction mixture showed signs of thickening. The flask was heated for approximately 16 additional hours at 70° C. The polymer solution was then diluted with 565 g of PC to make a 10% by weight polymer solution. GPC analysis was done on the polymer using polystyrene standards and tetrahydrofuran as a mobile phase. The analysis indicated that the polymer formed had a number average molecular weight (Mₙ) of 327,000 g/mol and a weight average molecular weight (M_{w}) of 485,000 g/mol.

The polymer gel was prepared by mixing 2.29 g of 1,1′-bis(3-phenyl(n-propyl)-4,4′-bipyridinium tetrafluoroborate, 0.697 g of 5,10-dihydro-5,10-dimethylphenazine, 0.799 g of Tinuvin P, 12.2 microliters of a 1% solution of dibutyltin diacetate in PC, 42.0 g of PC, 317 microliters of TDI, and 100 g of the stock copolymer solution. The solution was backfilled into eleven electrochromic devices. The devices were allowed to gel overnight in an 85° C. oven. One part was split open to ensure gelation had occurred. Thermal shock testing was done on ten parts.

Thermal shock observations for a set of ten parts were as follows: wormholes were observed after being put into a −40° C. freezer for every device on most of the 14 cycles. After allowing the devices to warm to room temperature at the end of the last cycle, all showed signs of hair line defects, most noticeably in a two centimeter strip along the outer circumference of the device and, in particular, where wormholes were observed during the thermal shock portion of this experiment.

In accordance with the preferred inequality of the present invention, identified herein as f+2(log(r)/p)≧1.00, the data from Experiment 10 demonstrates that 0.611+2(log(2)/7.1)=0.696<1.00. Therefore, based on the foregoing inequality, the cross-linked polymer matrix of Experiment No. 10 is not self-healing which comports with the above-identified observations.

### Experiment No. 11

In this experiment, an electrochromic gel was made from the addition of MDI (4,4′-methylene bis(phenyl isocyanate)) to a copolymer of methylacrylate and 2-hydroxyethyl methacrylate. GPC analysis using polystyrene secondary standards indicated that the polymer used had a number average molecular weight (Mₙ) of 68,000 g/mol and a weight average molecular weight (M_{w}) of 219,000 g/mol. The molar ratio of hydroxyl groups to isocyanate groups for this experiment was approximately 2:1. The total concentration of copolymer and MDI in the electrochromic gel is 2.35%.

The electrochromic gel was made by the two-solution technique. The first solution was made by mixing 4.15 g of 1,1′-dioctyl-4,4′-dipyridinium tetrafluoroborate, 1.58 g Tinuvin 384, 103 g PC, and 30.95 g of a 20.0% stock solution of a 10:1 poly(methylacrylate-co-2-hydroxyethylacrylate) in PC. Mixing 0.392 g MDI, 1.32 g of 5,10-dihydro-5,10-dimethylphenazine, 0.049 g decamethyl ferrocinium tetrafluroborate, 0.038 g decamethyl ferrocene, and 138 g of PC made the second solution. The two solutions were mixed together, 48 microliters of a 1% solution of dibutyltin diacetate in PC was added to 142 g of mixed fluid and backfilled into six electrochromic devices then baked in a 70° C. oven overnight (circa 16 hours) to gel the electrochromic material. One device was split open to ensure gelation had occurred.

Thermal shock observations of the five electrochromic devices were as follows: of the five parts tested, two showed no signs of any wormholes and/or bubbles during any of the thermal shock cycles. Of the other three devices, one device had two occurrences of bubble forming, one had seven occurrences of bubble forming, and one had twelve occurrences of bubble forming. There was also one occurrence of wormholes in one device. All of the devices healed completely upon completion of the test with no residual damage.

In accordance with the preferred inequality of the present invention, identified herein as f+2(log(r)/p)≧1.00, the data from Experiment 11 demonstrates that 0.800+2(log(2)/2.35)=1.06>1.00. Therefore, based on the foregoing inequality, the cross-linked polymer matrix of Experiment No. 11 is self-healing which comports with the above-identified observations.

While the invention has been described in detail herein in accordance with certain preferred embodiments thereof, many modifications and changes therein may be effected by those skilled in the art. Accordingly, it is our intent to be limited only by the scope of the appending claims and not by way of details and instrumentalities describing the embodiments shown herein.

What is claimed is:

1. A gelled electrochromic medium for use in an electrochromic device, comprising:
at least one solvent;
an anodic electroactive material;
a cathodic electroactive material;
wherein at least one of the anodic and cathodic electroactive materials is electrochromic;
a self-healing, cross-linked polymer matrix which comprises a product of at least one of a first reactant having at least one of an adhesive/cohesive functional group and a cross-linking functional group and a second reactant having a cross-linking functional group;
wherein the following inequality is true: f+2(log(r)/p)≧1.00;
wherein f comprises Σ_{x/m};
wherein x comprises a value ranging from 0 to 2 for each element (A), aryl moiety (Ar), and cyclic moiety (Cy) of at least one of the first and second reactants;
wherein x comprises 0 if A or Ar is represented by one of the following structures: 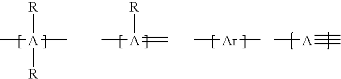
wherein x comprises 0.5 if A or Cy is represented by one of the following structures: 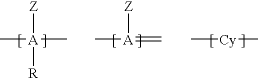
wherein x comprises 1.0 if A is represented by one of the following structures: 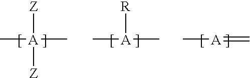
wherein x comprises 1.5 if A is represented by the following structure: 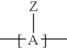
wherein x comprises 2.0 if A is represented by the following structure: 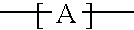
wherein A comprises C, N, O, S, P, or Si;
wherein Z comprises H or F;
wherein R comprises any other pendent group other than Z;
wherein m comprises the number of (A) elements, (Ar) moieties, and (Cy) moieties of the at least one of the first and second reactants which define x;
wherein r comprises the molar ratio of the adhesive/cohesive functional group of the first reactant to the cross-linking functional group of at least one of the first and second reactants; and
wherein p comprises the total concentration by weight of the self-healing, cross-linked polymer matrix in the gelled electrochromic medium.

2. The electrochromic medium according to claim 1, further comprising an ultraviolet stabilizer.

3. The electrochromic medium according to claim 1, wherein the average molecular weight of at least one of the first and second reactants is greater than approximately 2,000 daltons.

4. The electrochromic medium according to claim 1, wherein the average molecular weight of at least one of the first and second reactants is greater than approximately 5,000 daltons.

5. The electrochromic medium according to claim 1, wherein the average molecular weight of at least one of the first and second reactants is greater than approximately 10,000 daltons.

6. The electrochromic medium according to claim 1, wherein at least one of the first and second reactants comprises at least approximately 1.0% of the gelled electrochromic medium.

7. The electrochromic medium according to claim 1, wherein at least one of the first and second reactants comprises at least approximately 2.0% of the gelled electrochromic medium.

8. The electrochromic medium according to claim 1, wherein the first reactant having an adhesive/cohesive functional group is present in an effective concentration to, in turn, substantially diminish visual irregularities within the same.

9. The electrochromic medium according to claim 1, wherein the adhesive/cohesive functional group is selected from the group comprising a hydroxyl group, thiols, amines, amides, carboxylic acids, carboxylates, phosphonates, sulfonyl halides, silicate esters, ammonium salts, sulfonyl acids, siloxyls, silyls, cyanos, and combinations thereof.

10. The electrochromic medium according to claim 1, wherein the adhesive/cohesive functional group comprises a hydroxyl group.

11. The electrochromic medium according to claim 1, wherein the cross-linking functional group comprises an isocyanate.

12. The electrochromic medium according to claim 1, wherein the adhesive/cohesive functional group is selected from the group comprising a hydroxyl group, thiols, amines, amides, carboxylic acids, carboxylates, phosphonates, sulfonyl halides, silicate esters, ammonium salts, sulfonyl acids, siloxyls, silyls, cyanos, and combinations thereof, and wherein the cross-linking functional group comprises an isocyanate.

13. The electrochromic medium according to claim 1, wherein the molar ratio of the adhesive/cohesive functional group to the cross-linking functional group is greater than approximately 3:1.

14. The electrochromic medium according to claim 1, wherein the molar ratio of the adhesive/cohesive functional group to the cross-linking functional group ranges from approximately 3:1 to approximately 100:1.

15. The electrochromic medium according to claim 1, wherein the self-healing, cross-linked polymer matrix includes a backbone selected from the group comprising polyamides, polyimides, polycarbonates, polyesters, polyethers, polymethacrylates, polyacrylates, polysilanes, polysiloxanes, polyvinylacetates, polymethacrylonitriles, polyacrylonitriles, polyvinylphenols, polyvinylalcohols, polyvinylidenehalides, and co-polymers and combinations thereof.

16. The electrochromic medium according to claim 1, wherein the at least one solvent is selected from the group comprising 3-methylsulfolane, sulfolane, glutaronitrile, dimethyl sulfoxide, dimethyl formamide, acetonitrile, polyethers including tetraglyme, alcohols including ethoxyethanol, nitriles including 3-hydroxypropionitrile, 2-methylglutaronitrile, ketones including 2-acetylbutyrolactone, cyclopentanone, cyclic esters including beta-propiolactone, gamma-butyrolactone, gamma-valerolactone, cyclic carbonates including propylene carbonate, ethylene carbonate and homogenous mixtures of the same.

17. The electrochromic medium according to claim 1, further comprising a redox buffer.

18. The electrochromic medium according to claim 1, wherein the anodic electroactive material comprises a phenazine.

19. The electrochromic medium according to claim 1, wherein the cathodic electroactive material comprises a viologen.

20. An electrochromic device, comprising:
a first substantially transparent substrate having an electrically conductive material associated therewith;
a second substrate having an electrically conductive material associated therewith; and
an electrochromic medium according to claim 1 contained within a chamber positioned between the first and second substrates.

21. The electrochromic device according to claim 20, wherein the device is an electrochromic window.

22. The electrochromic device according to claim 20, wherein the second substrate is plated with a reflective material.

23. The electrochromic device according to claim 22, wherein the reflective material is selected from the group comprising chromium, ruthenium, rhodium, silver, alloys and/or combinations of the same, and stacked layers thereof.

24. The electrochromic device according to claim 23, wherein the device is an electrochromic mirror.

25. The electrochromic device according to claim 20, wherein at least one of the first and second substrates is less than approximately 1 mm thick.

26. The electrochromic device according to claim 25, where the device is an aircraft transparency.

27. An electrochromic device, comprising:
a first substantially transparent substrate having an electrically conductive material associated therewith;
a second substrate having an electrically conductive material associated therewith; and
an electrochromic medium according to claim 2 contained within a chamber positioned between the first and second substrates.

28. An electrochromic device, comprising:
a first substantially transparent substrate having an electrically conductive material associated therewith;
a second substrate having an electrically conductive material associated therewith; and
an electrochromic medium according to claim 3 contained within a chamber positioned between the first and second substrates.

29. An electrochromic device, comprising:
a first substantially transparent substrate having an electrically conductive material associated therewith;
a second substrate having an electrically conductive material associated therewith; and
an electrochromic medium according to claim 6 contained within a chamber positioned between the first and second substrates.

30. An electrochromic device, comprising:
a first substantially transparent substrate having an electrically conductive material associated therewith;
a second substrate having an electrically conductive material associated therewith; and
an electrochromic medium according to claim 10 contained within a chamber positioned between the first and second substrates.

31. An electrochromic device, comprising:
a first substantially transparent substrate having an electrically conductive material associated therewith;
a second substrate having an electrically conductive material associated therewith; and
a gelled electrochromic medium contained within a chamber positioned between the first and second substrates which comprises:
at least one solvent;
an anodic electroactive material;
a cathodic electroactive material, wherein at least one of the anodic and cathodic electroactive materials is electrochromic; and
a self-healing, cross-linked polymer matrix which comprises a product of at least one of a first reactant having at least one of an adhesive/cohesive functional group and a cross-linking functional group and a second reactant having a cross-linking functional group;
wherein the following inequality is true: f+2(log(r)/p)≧1.10;
wherein f comprises Σ_{x/m};
wherein x comprises a value ranging from 0 to 2 for each element (A), aryl moiety (Ar), and cyclic moiety (Cy) of at least one of the first and second reactants;
wherein x comprises 0 if A or Ar is represented by one of the following structures: 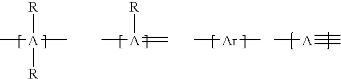
wherein x comprises 0.5 if A or Cy is represented by one of the following structures: 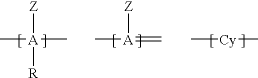
wherein x comprises 1.0 if A is represented by one of the following structures: 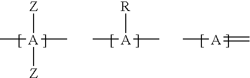
wherein x comprises 1.5 if A is represented by the following structure: 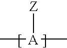
wherein x comprises 2.0 if A is represented by the following structure: 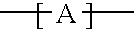
wherein A comprises C, N, O, S, P, or Si;
wherein Z comprises H or F;
wherein R comprises any other pendent group other than Z;
wherein m comprises the number of (A) elements, (Ar) moieties, and (Cy) moieties of the at least one of the first and second reactants which define x;
wherein r comprises the molar ratio of the adhesive/cohesive functional group of the first reactant to the cross-linking functional group of at least one of the first and second reactants; and
wherein p comprises the total concentration by weight of the self-healing, cross-linked polymer matrix in the gelled electrochromic medium.

32. An electrochromic device, comprising:
a first substantially transparent substrate having an electrically conductive material associated therewith;
a second substrate having an electrically conductive material associated therewith; and
a gelled electrochromic medium contained within a chamber positioned between the first and second substrates which comprises:
at least one solvent;
an anodic electroactive material;
a cathodic electroactive material, wherein at least one of the anodic and cathodic electroactive materials is electrochromic; and
a self-healing, cross-linked polymer matrix which comprises a product of at least one of a first reactant having at least one of an adhesive/cohesive functional group and a cross-linking functional group, and a second reactant having a cross-linking functional group;
wherein the following inequality is true: f+2(log(r)/p)≧1.25;
wherein f comprises Σ_{x/m};
wherein x comprises a value ranging from 0 to 2 for each element (A), aryl moiety (Ar), and cyclic moiety (Cy) of at least one of the first and second reactants;
wherein x comprises 0 if A or Ar is represented by one of the following structures: 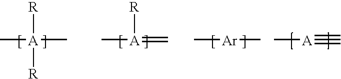
wherein x comprises 0.5 if A or Cy is represented by one of the following structures: 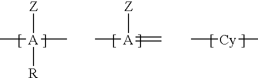
wherein x comprises 1.0 if A is represented by one of the following structures: 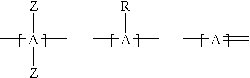
wherein x comprises 1.5 if A is represented by the following structure: 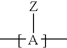
wherein x comprises 2.0 if A is represented by the following structure: 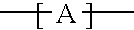
wherein A comprises C, N, O, S, P, or Si;
wherein Z comprises H or F;
wherein R comprises any other pendent group other than Z;
wherein m comprises the number of (A) elements, (Ar) moieties, and (Cy) moieties of the at least one of the first and second reactants which define x;
wherein r comprises the molar ratio of the adhesive/cohesive functional group of the first reactant to the cross-linking functional group of at least one of the first and second reactants; and
wherein p comprises the total concentration by weight of the self-healing, cross-linked polymer matrix in the gelled electrochromic medium.
